(19) United States
(12) Patent Application Publication
(10) Pub. No.: US 2004/0118942 A1
(43) Pub. Date: Jun. 24, 2004

(54) Mixed-fluid delivery system for body armor PFD, boater or cyclist

(76) Inventor: William L. Courtney, Elk, CA (US)

Correspondence Address: Daniel S. Polley, Esq., Malin, Haley & DiMaggio, P.A., 1936 South Andrews Avenue, Fort Lauderdale, FL, 33316, US

(21) Appl. No.: 10/623,117

(22) Filed: Jul. 19, 2003

Related U.S. Application Data
(60) Provisional application No. 60/397,065, filed on Jul. 19, 2002.

(51) Int. Cl. B05B 9/03

(52) U.S. Cl. 239/302

(57) ABSTRACT

A mixed fluid hydration system combines a multi-viscosity multi-ported valve body with field changeable valve cores providing single fluid valving with or without variable mixing to dilute carbohydrate and electrolytes fluids to match the varying physiological demands of prolonged exertion on the fly. A self-piercing self-sealing valve port allows piggybacking disposable delivery systems for straight on-off delivery or variable dilution. A single-use mixed-fluid bladder with self-piercing oral valves protects against dehydration and hypothermia at sea. A supported, film or thin film bladder that can only be inflated by compressed gas circumvents dual detonation and elevated pressure testing. A complementary lightweight film orally bladder provides redundancy of inflation means and chamber integrity. Over pressure protection on the oral bladder protects against accidental dual inflation while allowing for concurrent use of thin film technology. Cylinder seal spacer slows rate of compressed gas release into thin film while embedding inflator in the foam preserves the slim profile of Type III PFDs.

This Application claims the benefit of and priority to U.S. Application Serial No. 60/397,065, filed Jul. 19, 2002, which is incorporated by reference.

### FIELD OF INVENTION

This invention relates to fluid delivery systems, and more particularly to a dedicated compressed gas bladder and mixed-fluid delivery system for a body armor personal flotation device, boater or cyclist.

### BACKGROUND OF THE INVENTION

Sustained physical exercise results in idiosyncratic loss of fluids and electrolytes. Initially the body converts glycogen then fatty acids into adenosine Tri Phosphate (“ATP”) for utilization by the striated skeletal musculature, with a catabolic process that produces varying amounts of lactic acid in proportion to respiratory status and training ratio of quick to slow striated fibers summating as the individual's general physical condition. Metabolic status is also influences by the environment, specifically temperature and partial pressure of oxygen. Exertion at altitude in an environment of reduce oxygen impacts competitive performance or military survival. Overall the net result is that the cumulative loss of fluid and electrolytes and production of carbonic and lactic acid limit physical and mental efficacy as well as capacity.

Current hydration systems that provide only water to those under going extended physical exertion are not without serious consequences. While water is an important component when an individual consumes only water in response to sweating it can seriously complicate loss of electrolytes and potentially lead to disabling hyponatremia or hypokalemia. Electrolytes such as sodium and potassium are essential for functioning of nervous and muscular tissue. Deficiencies in either can compromise all areas of functioning ranging from attention to cardiac rhythms. Carbohydrates are also important to sustain clarity of mind and rapidity of response.

The physiology of exertion is a changing picture in which various nutrients are consumed, electrolytes and fluids lost, toxic products accumulate. As one progresses through different stages nutritional needs vary widely. The body craves the appropriate alimentation balancing needs for water, ions and glucose in proportion to the physiologic deficiencies and stresses before they become pathophysiologic. While prior disclosures provided the basic elements of water, ions and glucose they were delivered in an all or nothing fashion.

Prior alimentation systems in addition to allowing sustained performance provided cushioning from ballistic impact and contributed buoyancy to corrective turning. Inclusion of oral inflation means along with manual or water activated compressed gas bladders was considered common sense allowing the expensive still bulky laminated fabric bladder to at least be inflated if the inflator assembly fails for any reason. The combination of two means of inflation requires that the bladder be capable of being first inflated orally then upon immersion face over pressurization due to water activated detonation of the compressed gas cylinder. Over pressure relief is not allowed on the primary bladder because of the additional chance of catastrophic loss of buoyancy. It is allowed on secondary chambers.

Thus there remains a need for an alimentation system that allows the user to adjust the concentration of the various fluids demanded by the body to be instantly adjusted in accordance with evolving respiratory and metabolic. It is, therefore, to the effective resolution of the aforementioned problems and shortcomings of the prior art that the present invention is directed.

### SUMMARY OF THE INVENTION

The present invention provides an alimentation system that allows the user to adjust the concentration of the various fluids demanded by the body to be instantly adjusted in accordance with evolving respiratory and metabolic. A unified valve for simplicity of operation provides a range of alimentary supplements full strength or diluted to meets the demands of the moment.

Some supplements are best provided in a disposable format due to the difficulty in adequately cleaning the reservoir. Single use alimentation systems can remain sterile yet simply accessed by self-piercing valves. Existing disposable containers adapted to piggyback into the valve for straight delivery or mixing as desired.

The alimentation bladders contribute their buoyancy to a dedicated film compressed gas bladder which is complemented by a dedicated orally inflated bladder, the combined system concurrently confers redundancy of structure and inflation means.

Either the athlete or soldier can provide custom alimentation under way. The largest reusable would carry the water the smaller would carry a potable electrolyte drink. Additional bladders either reusable or disposable would carry a simple carbohydrate liquid and a complex carbohydrate solution including branched chain amino acids for sustained support of blood sugar. The tensioned delivery and valve system stays snug against the garment, ballistics vest or shoulder strap. A tri-glide version of the valve receiver can be adjusted along the length of the shoulder strap to fit any torso length. When thirst or hunger occurs the valve is pulled down and out of the garment mounted securing fixture and the valve then adjusted to pure water, electrolyte or one of the carbohydrate liquids.

If exertion has occurred at a sustained pace there maybe a mixed desire for both water and carbohydrate. The valve is adjusted to dilute the carbohydrate solution to a level of dilution that is optimal. An overly rich fluid could produce stomach cramps. The muscle aches from the loss of potassium and sodium is recognized with simple training.

The mixing valve includes an eccentric port on the valve core will allow delivery rates to remain unchanged as the user moves from straight water to a dilute protein drink.

The valves allows the infield addition of a number of potable sources of fluid if the reusable bladder has not been cleaned in days or weeks as might occur in war. The IV bag is common in a military setting and is source of clean fluids capable of supplying electrolytes and carbohydrates, if not palatable source.

An IV bag of DW 50 is a concentrated source of Dextrose and water, which can be diluted at the valve to provide support for blood sugar levels. The bicyclist can pick up a bottle of water or GATORADE sport drink and with a cap adapter plug it into the valve for continued sustenance.

The individual at sea is as in need of carbohydrates and hydration to fight hypothermia as the long distance cyclist. A sterile sealed chamber has a protected shelf life and is accessed by use of a self piercing oral valve that once the safety clip is removed can punch and regulate release of alimentary support.

Both the soldier with 30 lbs. of tactical plates and the boater wearing a comfortable low performance jacket can benefit not only from an inexpensive oral chamber but an inexpensive compressed gas bladder. A dedicated compressed gas bladder does not need to be capable of sustaining 8 psi by removing the threat of double inflation. Past fears were that the bladder would be first orally inflated then accidentally the water activate compressed gas would be released into a fully inflated bladder. Now the bladder fabric can be markedly thinner leading to lower profile reliable life jackets at a cost that can bring power inflatables into the row boater as well as the yachtsman.

Thus it is the primary object of the invention to provide tailored alimentary support to the soldier, cyclist and man over board.

It is also an object of the invention to provide a valve with multiple valve body inlet ports size according to viscosity.

It is also an object of the invention to provide a valve with multiple valve core ports size according to viscosity.

It is also an object of the invention to provide a valve with multiple eccentric shaped valve core ports shaped to provide consistent output.

It is also an object of the invention to provide a valve with multiple replaceable valve cores with different functions.

It is also an object of the invention to provide a valve with a valve core with raised ridge to allow easy manual removal.

It is also an object of the invention to provide a valve with multiple mechanical stops to identify the valves provision of either pure fluids or standard mixes of the base fluids.

It is also an object of the invention to provide a valve with multiple valve core ports size according to viscosity.

It is also an object of the invention to provide a cover bite valve with a quarter turn locking sleeve insert to allow easy remove to promote cleaning of carbohydrates from the alimentation system.

It is also an object of the invention to provide an interchangeable valve body with 2, 3, 4 or more input ports.

It is also an object of the invention to provide a valve with one or more ports for the addition of disposable sources of liquid nutrition.

It is also an object of the invention to provide a multi-chambered bladder for reusable carriage of fluids frequently used.

It is also an object of the invention to provide an adapter for attaching IV bags.

It is also an object of the invention to provide an adapter for attaching plastic bottles.

It is a primary object of the invention to provide a compressed gas life jacket that cannot be orally inflated.

It is a primary object of the invention to provide a compressed gas life jacket that cannot be orally inflated and is sized to keep the internal pressure within the limits of the bladder fabric.

It is an object of the invention to embed the inflator and cylinder with the foam for protection of thin film bladder on actuation, commercial storage of Type I SOLAS and cosmetic appearance of Type III.

It is an object of the invention to include the alimentary system in a jacket or garment.

It is to be understood that both the foregoing general description and the following detailed description are explanatory. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter.

### BRIEF DESCRIPTION OF THE DRAWINGS

For a fuller understanding of the nature and objects of the invention, reference should be made to the following detailed description, taken in connection with the accompanying drawings, in which:

FIG. 1 is an anterior view illustrating a hydration chamber on the inside of posterior aspect of a body armor vest. Two distinct chambers supply water and electrolytes. Two disposable chambers supply simple and complex carbohydrates. The combination allows maintenance of optimal attention and capacity during prolonged exertion. Mixed viscosity manifold valve body has interchangeable valve cores of on-off or mix mode functions allowing situational dilution as dictated by blood sugar, respiratory and metabolic acid base balance as well as level of hydration. An open lip grip covers the end of the valve allowing easy thorough cleaning.

FIG. 2 is a lateral view illustrating three different configuration of garment integrated alimentation. The first is an integrated system with a fused foam sandwich medially which shares a common wall hydraulic chamber immediately, which shares a common wall with the more exterior ballistics panel. One or more bladders provide residual impact protection. The middle drawing shows a fused body armor section with the hydration section being reversibly accessed for concurrent used of permanent and disposable bladders. The third drawing is a removable hydration system in which the welded insulating foam panel at reversible attached to the soft body armor vest as dictated by the specific operation.

FIG. 3 is a lateral view of a tension alimentation delivery system. The double lumen delivery tubing is secure to an elastic member attached to the vest. A vest-mounted clip receives a friction fit male member on the bottom of the mixer valve. This keeps the delivery system snug against the garment until needed.

FIG. 4 is a lateral view illustrating a multi-chambered alimentation system. It combines reusable and disposable bladders, which feed through a tensioned delivery system the specific ratio of carbohydrates, electrolytes and water either individually of as diluted as dictated by the greatest physiological deficit, a balance under constant evolution during extreme exercise.

FIG. 5 the upper drawing is an end view of the valve core illustrating the positions that are associate with delivery of a pure fluid or an infinitely varying ratio between two fluids. The lower drawing is a side view of the valve body illustrating the variation in the manifold port sizes in accordance with the viscosity of the fluid to maintain similar rates of flow. The friction stops built into the valve body identify the pure or mixed positions of the valve core.

FIG. 6 is a lateral drawing illustrating a 2, 3 and 4 port valve body. The upper drawing includes a valve core with eccentric ports the diameter of which reduces as the valve moves from a single fluid to a combination. The combined area of the ports is such that it equals the area of a single port so that the output delivery remains constant as the valve is changed from pure water to pure electrolytes to pure carbohydrates of varying degrees of dilution. An oversized valve handle allows manual exchange of the valve core to match the alimentary needs of a given mission.

FIG. 7 is a lateral view illustrating the use of a dedicated compressed gas chamber in a body armor vest and PFD. The inability to orally inflate the compressed gas chamber allows the use of lightweight fabrics that neither need nor could pass standard double inflation tests. Separate chamber that is orally inflated can have an over pressure relief valve in the unlikely event of concurrent inflation. Dual film bladders provide structural redundancy and two means of inflation. The embedded IF water activate inflator maintains the same profile, critical with Type III cosmetic PFDs.

FIG. 8 is a lateral view illustrating a self-piercing oral valve for use with single use hydration bladders. A removable lock keeps the piercing port from opening the sterile seal. Once removed the spring-loaded valve can be punched through the seal accessing the combined source of carbohydrates, electrolytes and water. The lock can be re-insert to prevent inadvertent loss of nutrients.

FIG. 9 is a lateral view illustrating a reduced flow shim for a IF water activated inflator. The reduced pierce aperture reduces flow rate protecting the thin film bladder during compressed gas inflation.

FIG. 10 is a lateral view illustrating an adapter cap for connecting disposable bottles to augment the mixed fluid hydration system. The adapter cap allows the use of sterile packaging to be piggyback into the third port of the tensioned delivery valve. Alternative use of 4 independent valves inline regulates delivery to a common manifold the means of a range of fluids for meeting a diverse range of alimentation needs as occurs across a wide range of activities from sitting to continuous strenuous exercise.

FIG. 11 is a lateral view illustrating a selection of valve core patterns allowing in field adaptation of the hydration alimentation system to take advantage of available supplies. While the supplements supplied with the hydration alimentation system are all capable of being combined in the urban theatre acidic fluids such as orange juice would coagulate milk proteins and so the valve core can be quickly changed from a variable dilution operation into a strict on-off operation.

FIG. 12 is a combined lateral and posterior view illustrating a posterior and anterior high viscosity delivery system in which the high viscosity bladder is compressed by straps or tensioned elastic fabric that keeps the thick viscous contents under pressure. Locate at the highest points reduces need to draw the viscous supplement through a long hose against gravity.

### DETAILED DESCRIPTION OF THE PREFERRED EMBODIMENT

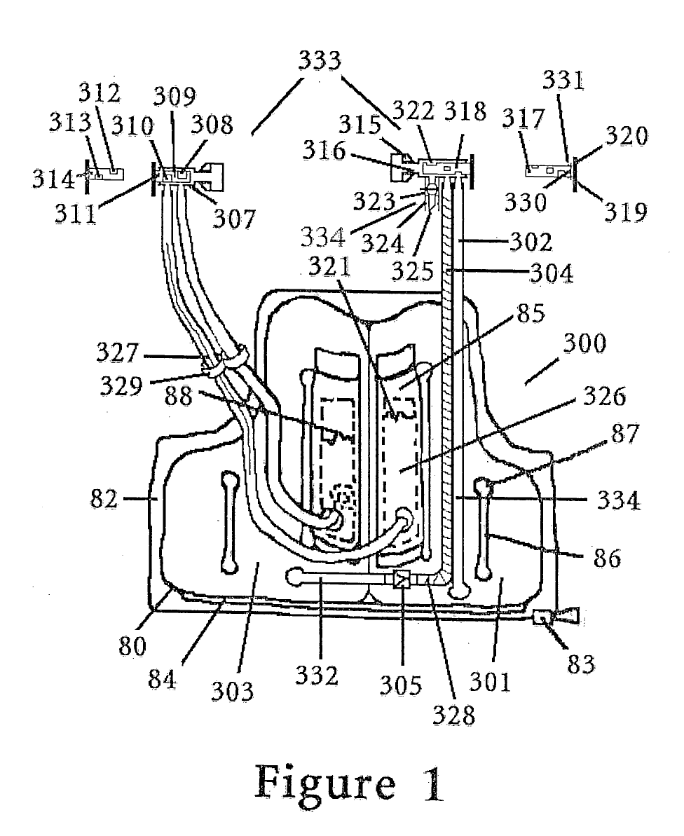

As seen in the drawings a dedicated compressed gas bladder and mixed-fluid delivery system for body armor, personal flotation device (“pfd”), boater or cyclist is illustrated. In FIG. 1 a cushioning chamber 80 contains a multi-chambered alimentation system 300. Water maybe contained in chamber 301 while an alternate fluid electrolyte drink is in chamber 303. The multi-chambered alimentation system can be located between the body armor vest and the back and/or the front 300. Two disposable bladders 326 can be housed within pockets 85 for carrying bladders of carbohydrate fluids that can not be easily cleaned. The fluid level in the left disposable bladder 88 can be different that the level in the right disposable bladder 321 reflecting differing needs for the nutrients. A dual lumen delivery tube 334 connects chamber 301 via lumen 302 and connects chamber 303 via lumen 304 to a multi-viscosity port on-off and mixing valve 333. Valve 333 can be configured with varying number of input ports into a valve body manifold 307. The right valve connected to bladders 301 and 303 has 3 ports the third port is a spare for attaching disposable supplements. It has an piercing member 325 and an a sealing member 324 and a separate flow rate valve 323 for matching the flow through the wide bore port 322 in the currently installed valve core 318. The installed valve core 318 has three ports each of which can be separately turned on or off. Oral suction applied to bite valve 315 draws nutritional supplements from chambers 301 and 303 as regulated by valve core 318. A quarter turn mounting means 316 of bite valve 315 allows easy removal for cleaning of the high carbohydrate solutions passing through valve 333. Alternate valve core 317 incorporates three on-off valves and a mixing valve function that allows the fluids in 301 and 303 to be combined in any ratio. Valve handle 319 is continuous with the valve core. Raised ridge 320 allows easy manual extraction of the valve core from the valve body. The valve core is locked into the valve body by friction lock 331. O-Ring 330 seals the valve core and valve body.

In FIG. 1 the separate delivery tubes from disposable bladders 326 are connected by friction clamp 329 and adhesive wire 327 allows the delivery tubes to retain any particular shape once they have been bent into that shape. Lumen 304 includes a wound wire within the body of the tube 328 to allow memory upon bending dual lumen 334 into a desired delivery position. Right angle connector 332 does not have the integrated wire 328 found in lumen 304.

In FIG. 1 the two disposable bladders deliver their contents to dual manifold body 307 where the valve core 311 that is installed in body 307 has two elongated ports that allow passage of only a single fluid valve core ports 308 or 310 are aligned with manifold input ports in the valve body 307. Alternatively the two fluids can be mixed when the valve core is in position 309 allowing fluids from both inputs to be drawn off at the same time in any of an infinite number of combinations. Alternate valve core 314 can be installed in valve body 307 allowing only simple on off access through port 312 or through port 313 allowing consumption of fluids one at a time.

The various fluids contained in cushioning chamber 80 are mounted on an adapter 82 allowing the same configuration of bladders to be reversibly mounted 83 on a variety of body armor vest or other garments. The soft body armor 82 can be sealed onto the backside of the hydraulic cushion 80 providing protection of moisture and immersion. Baffles 86 in bladders 301 and 303 limit the amount of bulging allowed as dictated by the function of the supporting garment. The baffles terminate in button 87 to distribute the force applied by the bladder contents. When the multi-fluid alimentation means is used behind the wearer a check valve 305 prevent the installation of air as posterior air trapping opposes corrective turning. When the hydraulic cushion is mounted in front of the wearer, air can be instilled to keep the empty bladders inflated in order to provide protection from ballistic impact.

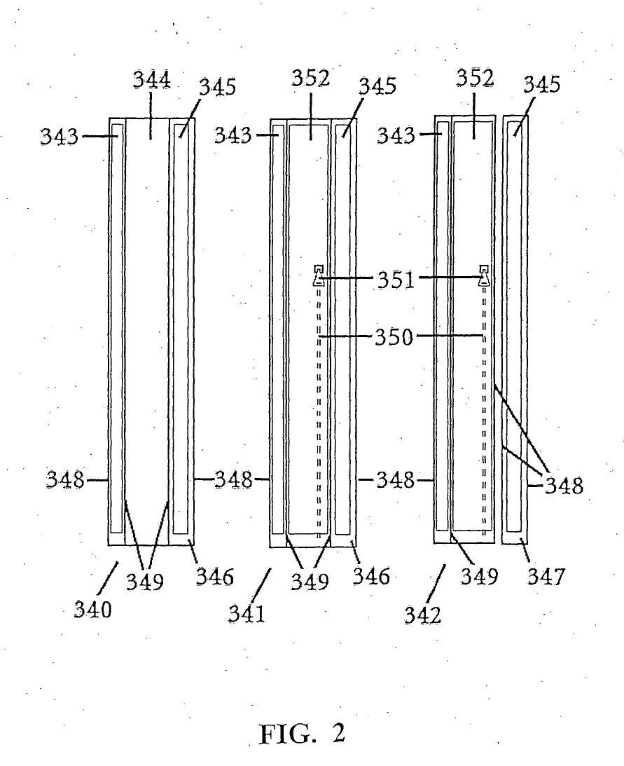

In FIG. 2 the left hand drawing 340 shows the use of fabric laminated on both sides 349 to allow the KEVLAR panel 345 which occupies space 346 to be made from a layer of fabric coated on a single side 348 welded to the double laminate 349. An insulating soft foam 343 is welded to the exterior single laminate 348 and the double laminate 349. The two layers of double laminate are welded creating chamber 344 for storage of fluids. The second drawing shows a reversible closure means 350 with zipper pull 351 allowing the installation of one or more bladders 352 for storage of mixed fluids. The third drawing shows a two chambered system comprised of the welded foam 343 and hydration bladder 352 separate from the KEVLAR panel 345 contained ballistics vest pocket 347. Allowing the insulated hydration system to be used only when indicated.

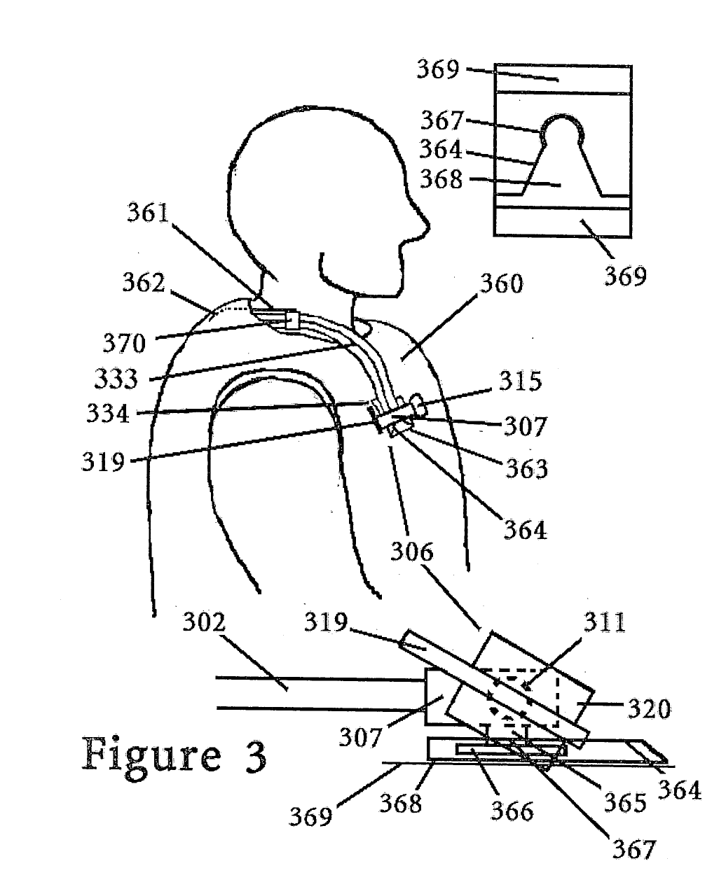

The posterior hydraulic-hydration system is delivered in FIG. 3 through a delivery system 360 under tension generated by tensioning member 361 secured to dual lumen delivery tube 334 at compression slide 370. Tensioning member 361 is fixed to the garment or body armor vest at 362. Valve body 307 has an inferior post 365 with an enlarged mounting base 366 that is guide through funneled receiver 364 until the post 365 engages friction snap lock 367. The base of the receiver 368 is fused to sewable margins 369 allowing garment mounting. The valve handle 319 is turned so that the ports in valve core 311 can align with the lumen to delivery tube 302. The exterior margin of valve core 311 is enlarged at 320 so that valve core 311 can be easily removed from 307 for cleaning or exchange with alternate valve cores.

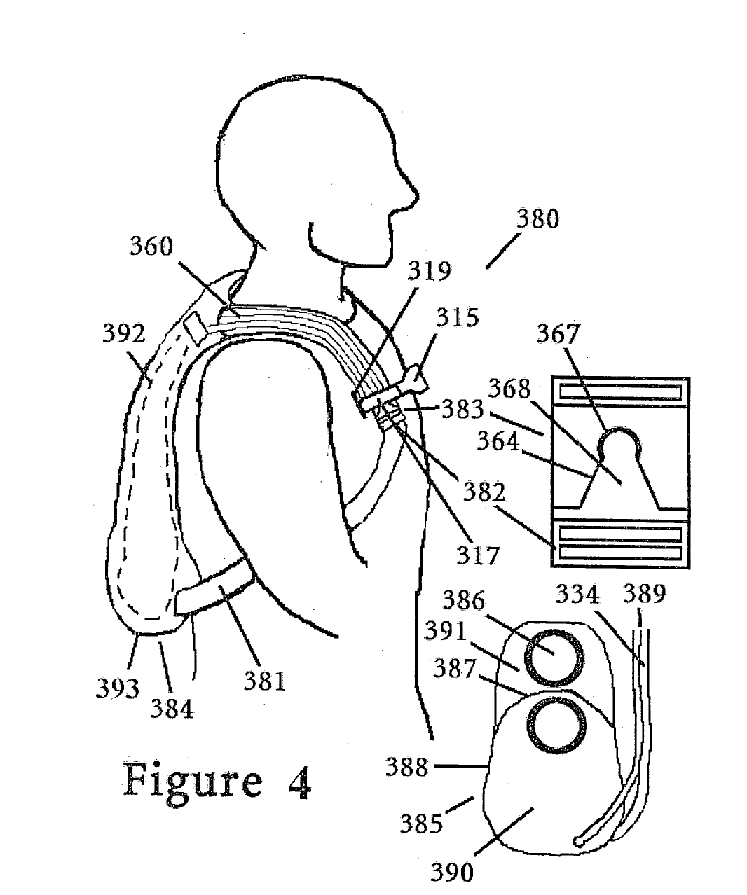

In FIG. 4 the continuously variable mixture of fluids supplies a wide range of alimentary needs 380. The back mounted alimentation system mounts the friction lock valve receiver 383 on the shoulder strap 381 by way of an integrated tri-glide adjustment 382. The multi-bladder liquid nutrition system 384 combines disposable bladder 392 such as potable Intra-Venous fluids available at remote sites, with reusable bladders 385 which is shown here as a three layer dual chambered bladder. Large fill ports 386 allowing cleaning and installation of ice. The top layer is welded at 387 to the lower layer and all three layers are welded about the perimeter at 388. Dual lumen delivery tube 334 leads to the diluting valve 389 so that the viscous carbohydrate solution in the smaller bladder 390 can be diluted with the water in the larger bladder 391 when valve handle 319 is in position to allow passage of sustenance through bite valve 315.

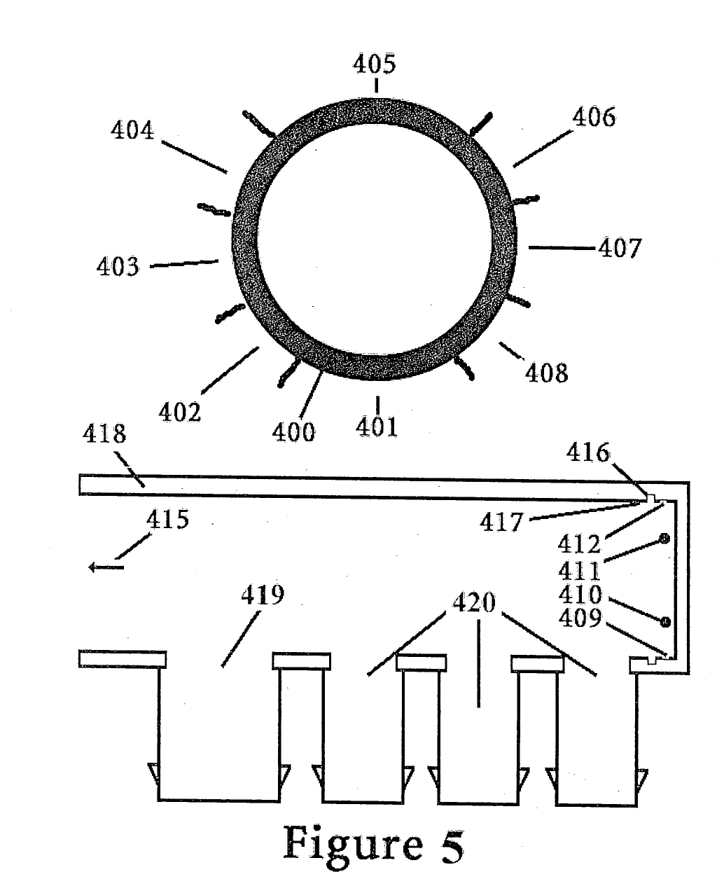

In FIG. 5 the top drawing is of an end on view of the valve core 400 showing the various valve operations as a function of position. The valve is closed when the handle is located at 401. Position 402 allows access to just fluid A. Position 403 allows fluids A and B to be mixed or diluted. Position 404 provide the individual with pure fluid B. Position 405 mixes fluids B and C, position 406 pure fluid C, 407 mixed fluids C and D, 408 pure fluid D. The lower drawing shows a 4 port valve body manifold 418 with a large high viscous port 413 and three low viscous ports 414. The valve body mounted friction stops for the valve core handle correlate as follows: Off position friction stop 409, pure fluid A 410, pure fluid B 411, 50:50 mix of fluid B and C 412. Within the valve body friction lock receiver 416 secure valve core to valve body 418. The sealing face for core mounted O-Ring is found at 417.

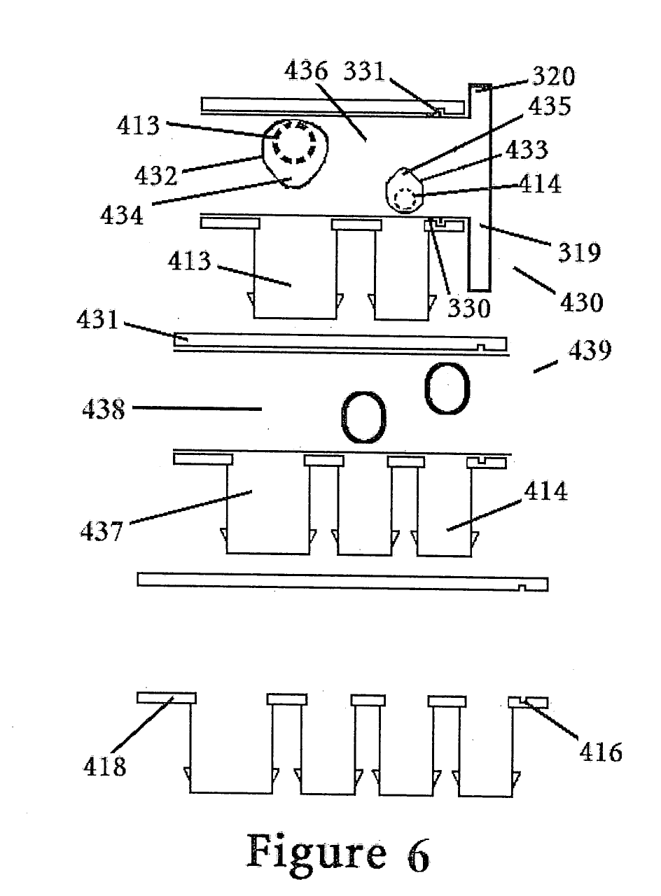

FIG. 6 compares the two port mixer valve 430 with the three port mixer valve 431 with the four port mixer valve 417. The upper drawing shows an eccentrically ported valve core 436 inside the mixed viscosity dual ported manifold valve body 430. The high viscosity valve body port 413 is shown superimposed diagrammatically at on the valve core port 432 to show its eccentric shape. The valve core port is reduced 434 in the area of mixing to maintain the same flow rate. Similarly the low viscosity valve body port 414 is also superimposed on the valve core port 433 to illustrate how the diameter of the port 435 is reduced when mixing. The raised lip of the valve core 320 allows purchase to over come the friction of valve core mounted lock 331 from valve body receiver 416 allowing removal from valve body for cleaning or conversion to a valve core without fluid blending.

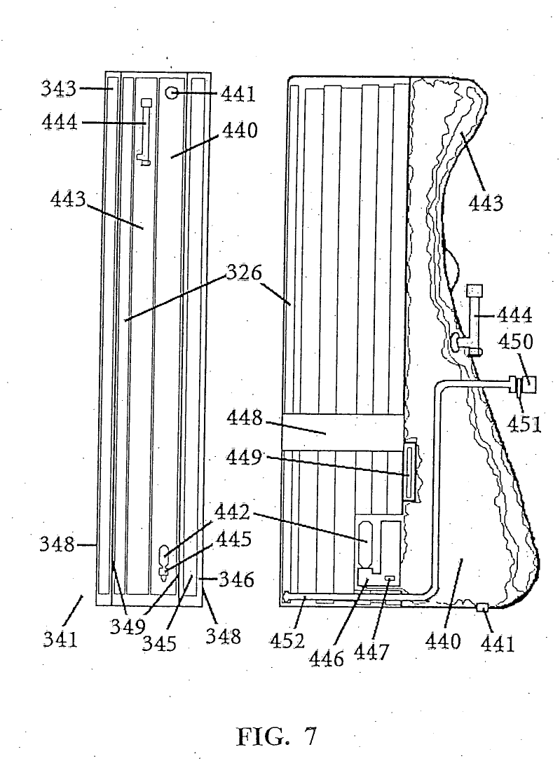

FIG. 7 the left-hand drawing illustrates the use of dedicated compressed gas inflated chamber 440 used concurrently with dedicated orally inflated chamber 443. The lack of a means of oral inflation of the compressed gas chamber allows the use of lightweight fabrics incapable of passing current double inflation and sustained elevated pressure tests. A deflation valve 441 allows reuse of the compressed gas bladder 440 if not a single use product. The oral inflator can mount an over pressure relief valve 444 to protect oral and compressed gas chambers. The drawing on the right is a triple chamber vest with reversible closure means on the middle chamber 341 and demonstrates a current water activated inflator 445 attached to a compressed gas cylinder 443 on a film bladder within a ballistics vest. A hydration bladder 326 is also located behind ballistics panel 345 in pocket 346. The drawing on the right demonstrates inclusion of dedicated compressed gas 440 and oral bladders 443 in a hybrid configuration. The IF water-activated inflator 446 provides cylinder seal indication at 447 to inform of the status of compressed gas cylinder 442. The foam layers in the inherently buoyant component of PFD are retained by strap 448. The interlaced chest strap 449 passes around foam but beneath the inflatable bladder. Disposable hydration bladder 326 is stored posteriorly where narrow gauge single use delivery tube 452 leads to a self piercing valve 450 that is locked inactive by clip 451.

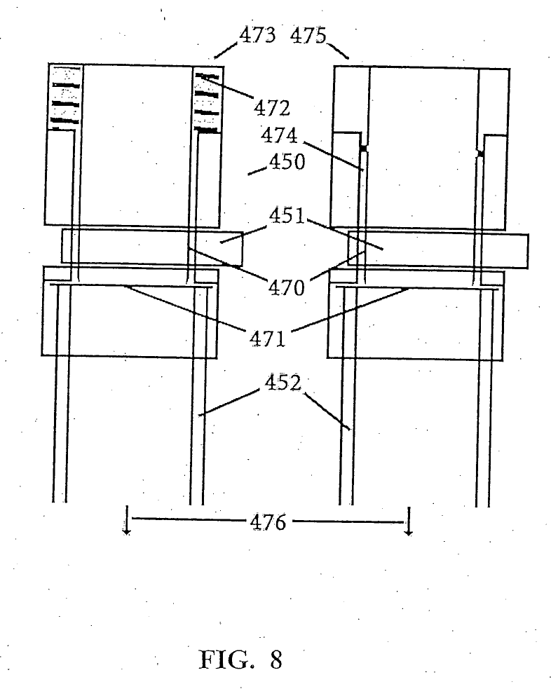

FIG. 8 show a pair of self-piercing valves, a spring 472 driven valve 437 and a friction fit 474 valve 475. Both rely upon a locking clip 451 to keep the piercing port 470 from puncturing the sterile seal 471. The valves can be directly attached to delivery tubes 452 leading to attached disposable bag 476. Locking clip 451 can be replaced once seal 471 has been punctured in valve 473 to prevent leakage. Friction valve 475 has to stay in the down position in order to close and prevent inadvertent leakage.

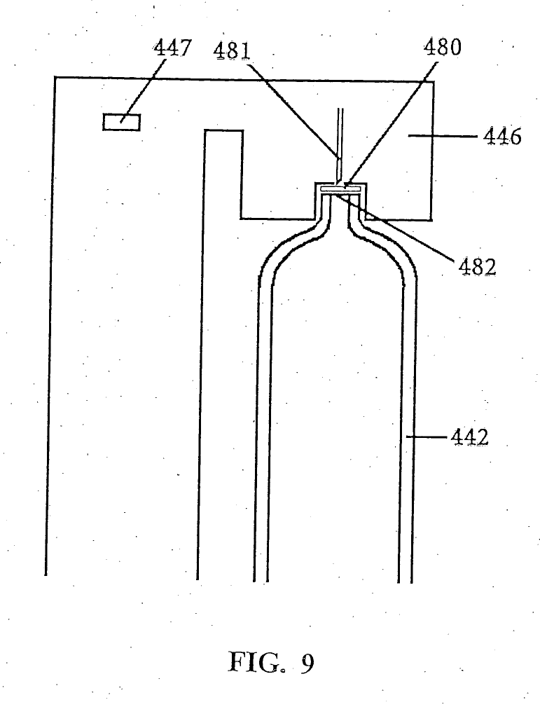

FIG. 9 demonstrates a reduced flow spacer 480 interposed between compressed gas cylinder 442 and 1 F inflator 446. Reduced flow space prevents piercing pin 481 from creating as large of an opening in cylinder seal 482 thereby restricting discharge rate protecting film and thin film bladders.

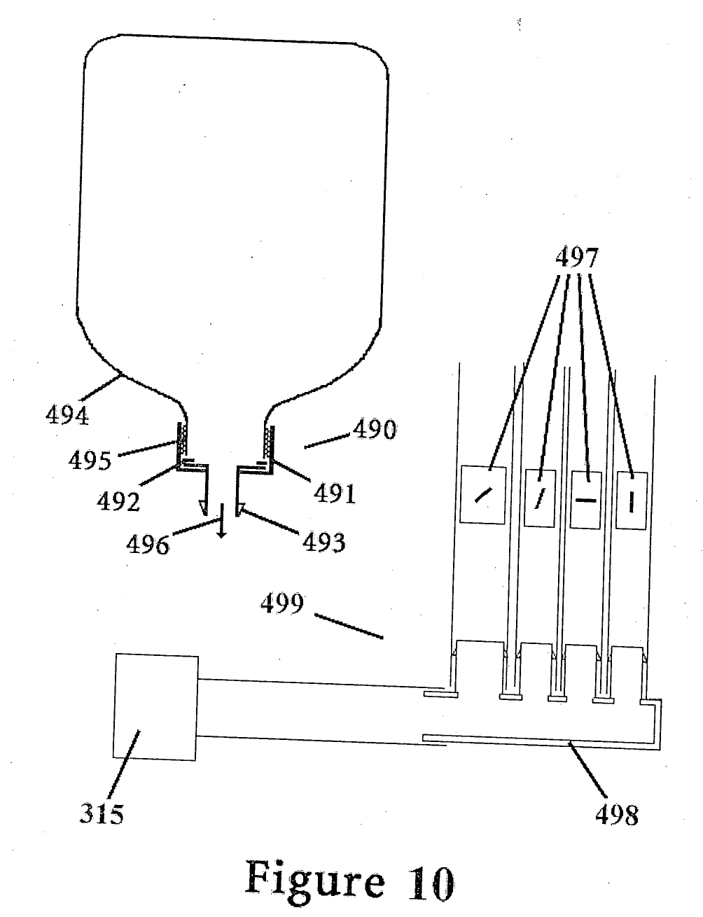

FIG. 10 is bottle adapter 490 in which a threaded cap 491 threaded 495 onto bottle 494 mounting an orifice through which passes a barbed adapter 493. The adapter is sealed to the bottle 494 by way of gasket 492. Fluid is passed through tubing secured to barbed adapter 493 on to piggy back port 496 on mixer valve.

The lower right hand drawing in FIG. 10 is of an alternative means to mix a diverse range of liquid supplements 499. A series of two or more inline valves 497 allow the down stream fluid to be drawn into the mixing manifold 498 and then passed through the lip grip 315 into the mouth of the soldier. During strenuous exercise the viscous fluids are turned off or reduced by adjusting inline valve means while water or rapid access high glycemic fluids are proportionally increased. During anabolic periods the body can tolerate highly viscous fluids with their increased protein and complex carbohydrate content as are needed to rebuild tissue and energy stores. If the soldier is required to sustain strenuous activity the induced catabolic state prefers dilute short chain sugars, electrolytes to replace the water and electrolytes. The inline series of valve are harder to clean and more difficult to use than the previously disclosed multi-ported and eccentrically ported single valve.

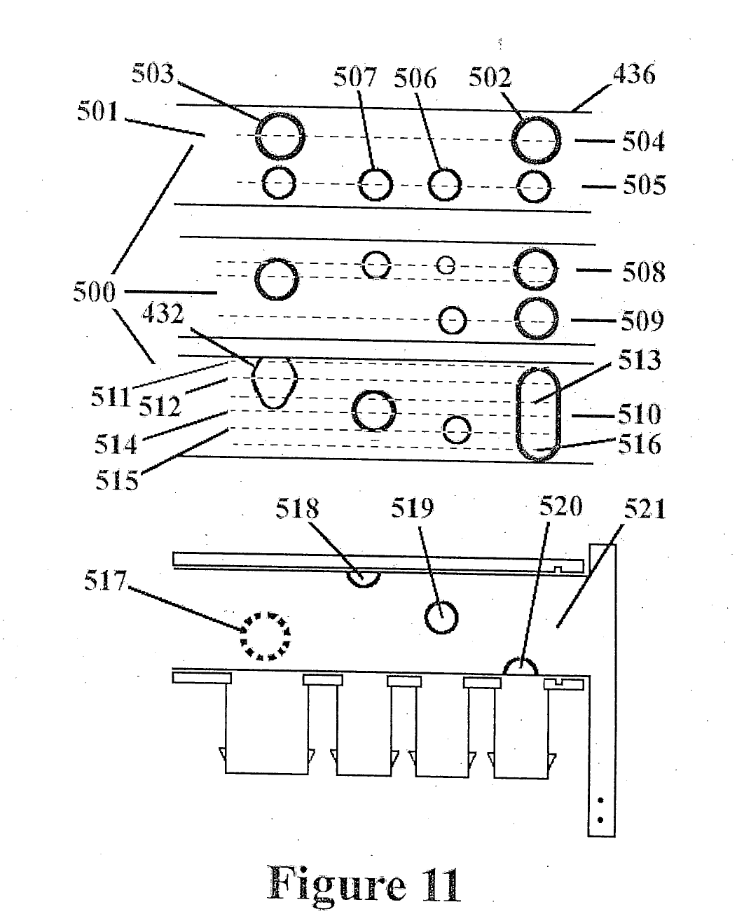

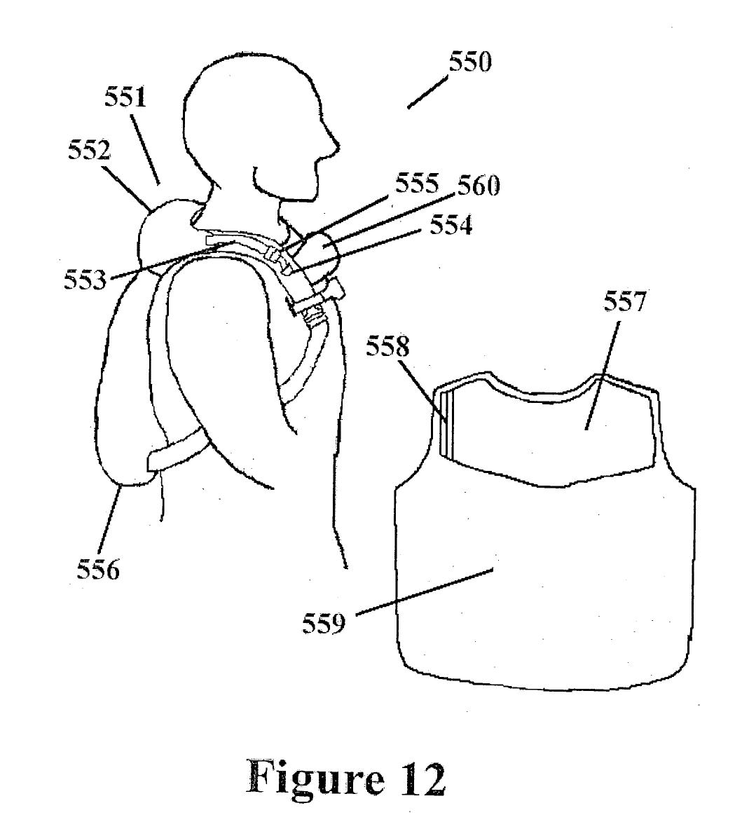

FIG. 11 illustrates a diverse flexibility available in porting the valve core 500 to meet the specific metabolic requirements under associated with any level of exertion. The top drawing in FIG. 11 is of a valve core 436 in which High viscosity nutrition orifice 503 is aligned with the water orifice 502. This simple arrangement allows mixing in proportion to the fluids draw rate, the thicker fluid drawing slower which can be compensated for by mechanical or elastic pressure systems as seen in FIG. 12. The lower row of ports in the same valve core shows all four fluids supplied maximally at the same time 505. This includes water 502, high glycemic index sport mix 506 such as, but not limited to, GATORADE sport drink, a low glycemic index including branch chain amino acids 507 and highly viscous high protein nutritional supplement 503 such as, but not limited to, ENSURE supplement. This fully ported delivery would have the greatest rate of caloric supply and would be optimized by the preparation of the particular supplements used. In the second valve core porting layout, a specific need is anticipated such as extreme endurance cycle racing for which an idealized combination of anabolic and catabolic needs have been determined. The valve core and body can include a specific friction stop to alert the athlete to the location of the preset mix as seen in FIG. 5.

The lower row of ports in the second valve core is a simple dilution of the high glycemic index supplement as might occurs in peak exertion. A frequent mix that also might be indicated by a friction stop so the cyclist can quickly set the nutritional delivery system. The third valve core in drawing 11 is of a more fluid design that allows the cyclist to have access to pure water 516, or a as the cyclist turns the valve they are delivered a dilute mix of high glycemic index 506 with a bit of slow release low glycemic index substrate 507. On long down hill run the cyclist can increase the percent of complex carbohydrates 514. At and extended break the cyclist can move to a dilute mix of the protein drink 512 to straight protein drink 511.

In the lowest drawing of FIG. 11, a valve core allowing independent access to each liquid supplement 521. The port facing straight down 521 is in position to supply the soldier straight water. As the valve core is turned with the valve body the soldier access straight high glycemic index support such as, but not limited to GATORADE sport drink. As the soldier continues to adjust the valve with one hand they access a straight low glycemic index supplement 518 which adds in complex carbohydrates and branch chain amino acids to reduce the incidence of fatigue. As the valve is turned further the soldier sitting for hours or days can tolerate the high osmoality protein drink 517 indicated on the back side of the valve core. When it is aligned connect the input port and mouthpiece the draws in the highly viscous protein drink that would cause the exercising (catabolic) soldier to choke but is ideal for the sedentary (anabolic) sniper in position for days on end.

In FIG. 12 a mixed viscosity delivery system 550 relies upon multiple means to help move the thick protein fluid through the draw tube. The high viscosity bladder 557 is located high on the back of the posterior garment 559 where gravity helps delivery 551 or high on the chest 560. In addition an elastic cover 552 which can be re-tensioned even if on the move by manual means 553 in which tension is applied to pull means 554 attached to a strap held under tension by locking means 555. As the high viscous supplement is drawn off, the strap is pulled on an tension stored in the elastic cover 552. While the whole cover could be elastic, the lower half can also be made from traditional, more durable fabric 556. While the high viscosity bladder is often disposable if that is not possible an over sized yet pressure proof opening 558 allows the inside of the bladder to be scrubbed. Tubing brushes as common in the field can be used to clean the delivery tube.

It should be recognized that the present invention is not limited to any number of valve ports, nor is the invention limited to any particular fluids, vitamins, minerals or supplements. It should also be recognized that the various valve embodiments described above can be interchangeable with the various bladder/chamber configurations described above.

### Index of Reference Numerals for Hydration System

80 Cushioning chamber containing fluid, gas or a combination of both mounted onto waterproof ballistics cover located within vest or independent chamber mounted within the vest walls on the inside of the vest directly adjacent to the wearer, all positions protected by body armor

82 Garment specific adapter allowing a single size hydration/hydraulic shield to be mounted within or upon a wide range of ballistics vests

83 Reversible mounting means allowing body armor garment to add or remove hydration, alimentation and pneumatic residual-impact protection chambers

84 External welded closure seam for hermetically sealing water sensitive ballistics fabric away from water

85 Internal pocket welded on the inside or outside of back layer, to hold replaceable soft canteen

86 Break point baffle limiting thickness of air/water cushion

87 Baffle termination button to distribute the force of rapid pressurization upon deformation secondary to ballistic impact

88 Fluid level of high caloric alimentation

300 Anterior or posterior hydration system

301 First water tight chamber

302 Delivery tube for first chamber

303 Second water tight chamber

304 Delivery tube for second water tight chamber

305 Check valve for use of posterior chamber to prevent influx of air into chamber

306 Variable function manifold valve with two or more interchangeable valve cores

307 Manifold valve body with two or more inputs

308 First sole input position on multi-operation valve core

309 Variable dual input section of valve core

310 Second sole input position of multi-operation valve core

311 Exchangeable valve core with two separate on-off operations and a variable mixer operation

312 Inside valve orifice

313 Outside valve orifice

314 Alternate exchangeable valve core with two separate on-off valve operations

315 Soft lip grip

316 Open smooth bore valve outlet orifice

317 Triple valve core, combining three separate on off valves with one two line mixer

318 Exchangeable valve core with three separate on off valves

319 Valve handle

320 Valve body extraction overhang, for manual removal/exchange of functionally valve cores

321 Different fluid level in second disposable or limited re-use fluid container

322 Large bore viscous fluid port in valve core

323 On-Off and flow rate control valve

324 O-ring sealed receiver with tubing stop

325 Seal piercing straw

326 Disposable grade or sterilize-able grade waterproof chamber for containment of liquid nutrition, electrolytes or water

327 Adhesive wire for bending delivery tube into shape

328 Wire built into to tube for holding curves in delivery tube

329 Tube clamp for pair of disposable delivery tubes

330 Valve core to valve body O-Ring seal

331 Valve core valve body friction lock

332 Welded right angle connector

333 Dual lumen tube

334 Piggyback port for adding nutritional supplements found in the field

340 Triple welded chamber including foam and hydraulic cushion of encapsulated soft body armor

341 Triple chamber with reversible closure means accessing center chamber

342 Dual chamber foam-hydraulic chamber attached to body armor vest

343 Open cell foam welded to laminated fabric

344 Water proof center chamber

345 Soft ballistics panel

346 Hermetically sealed ballistics panel enclosure integrated onto hydraulic chamber

347 Ballistics panel enclosure as component of body armor vest

348 Fabric laminated on single side

349 Fabric laminated on both sides

350 Reversible closure means

351 Zipper pull

352 Waterproof hydraulic/hydration chamber

360 Tensioned hydration delivery system

361 Elastic member

362 Attachment means between garment and tensioning member

363 Garment mounted receiver for securing delivery means to garment

364 Funneled approach to valve mounted locking post

365 Valve body mounting post

366 Valve body mounting base

367 Friction snap lock

368 Base of friction snap lock

369 Sewable plastic tab

380 Continuously variable delivery mixed-fluid hydration system.

381 Shoulder strap

382 Triglide adjustable webbing lock

383 Shoulder strap mounted friction lock valve receiver

384 Multi-bladder liquid nutrition system combining multiple refillable bladders and or single use bladders in variable combination as dictated by program demands

385 Three layer dual chamber alimentation bladder

386 Large fill/clean port

387 Weld between top layer and middle layer

388 Perimeter weld of all three layers

389 To diluting valve

390 Smaller liquid food chamber

391 Larger water chamber

392 Emergency IV bag sterile hydration

393 Outer fabric back pack containing reusable and/or disposable fluid bladders

400 End on view of exchangeable valve core with four on-off valves with three mixer valves

401 Off position

402 Pure fluid A

403 Mixed fluid A and B

404 Pure fluid B

405 Mixed fluid B and C

406 Pure fluid C

407 Mixed fluid C and D

408 Pure fluid D

409 Valve-body mounted valve-core stop for off position

410 Valve-body mounted valve-core stop for pure fluid A

411 Valve-body mounted valve-core stop for pure fluid B

412 Valve body mounted valve core stop for 50:50 mix of fluid B and C

413 Superimposed high viscosity valve body input port inlet

414 Superimposed low viscosity valve body input ports inlet

415 Valve body exit to mouth

416 Valve core to valve body snap friction lock

417 Valve core to valve body O-Ring seal surface

418 Four port valve body

419 High viscosity port valve body inlet

420 Low viscosity port valve body inlets

430 Mixed viscosity 2-port manifold valve body

431 Mixed viscosity 3-port manifold valve body

432 Eccentric valve core high-viscous port

433 Eccentric valve core low-viscous port

434 Reduced valve core orifice diameter in high viscosity port

435 Reduced valve core orifice diameter in low viscosity port

436 Valve core body

437 Piggy back port with piggy back valve built into valve core

438 Valve core with no port for introduction or loss of fluid through piggy back port

439 Pure water, pure high glycemic supplement and infinitely variable dilution of supplement with piggyback port eliminated

440 Compressed gas chamber made of minimally supported, film or thin film fabric without means of oral inflation

441 Deflation valve

442 Compressed gas cylinder

443 Oral inflation chamber

444 Oral inflation tube with optional over pressure relief valve

445 Current water activated compressed gas inflator

446 Pending IF water activated compressed gas inflator

447 CSI Cylinder Seal Indicator

448 Layered foam retainer means

449 Interlaced chest strap around inherently buoyant means beneath inflatable means

450 Self piercing oral valve

451 Self-piercing and valve-lock clip

452 Delivery tube from single use alimentation bladder

470 Piercing port

471 Sterile seal

472 Normal closed temporarily open valve and piercing port

480 Reduce flow-rate spacer for thin film inflation

4811F piercing pin

482 Cylinder seal

490 Bottle adapter

491 Universal threaded lid with adapter orifice

492 Gasket

493 Barbed delivery tube adapter

494 Bottle

495 Threads

496 To piggyback port

497 Independently operated inline valves

498 Simple mixing manifold

499 Alternative valving for liquid alimentation system.

500 Selection of interchangeable valve core patterns

501 Discrete mixing valve core pattern

502 Water orifice

503 High viscosity nutrition orifice

504 Accessing and combining water and high viscosity nutrition

505 Accessing and combining all fluids

506 High glycemic index ‘sport mix’ port

507 Low Glycemic index sustain carbohydrate port

508 Preset ideal proportioned mix of water, low and high glycemic and thick viscosity fluids

509 Straight dilution of high glycemic i.e. sugar water with pure water.

510 Continuous dilution by water of high glycemic then high glycemic and low glycemic then low glycemic with increasing amounts of high viscosity then pure high viscosity supplement.

511 Track of Pure High viscosity High Protein rich nutritional supplement

512 50 to 50 High Viscosity and water

513 Fraction of High viscosity and fraction of Low Glycemic maximally diluted with water

514 Minimum High Viscosity with Maximum Low Glycemic with minimum of High Glycemic fully diluted with pure water.

515 Minimum Low Glycemic with Maximum High Glycemic fully diluted with water

516 Straight water

517 Solitary inputting high viscosity port facing into page, on back side of hollow valve core body.

518 Solitary inputting low glycemic port facing straight up

519 Solitary inputting high glycemic port facing out of page

520 Solitary inputting water port face straight down

521 Valve core allowing Independent on-off valving for incompatible nutritional supplements

550 Mixed viscosity delivery

551 Gravity enhanced delivery of high viscosity supplement

552 Elastic fabric, compressed delivery of high viscosity supplement

553 Manual re-tensioning adjustment means

554 Strap pull means

555 Adjustable strap locking means

556 Non-elastic back pack cover fabric

557 High viscosity bladder

558 Waterproof over sized opening for cleaning

559 Posterior of garment (or high anterior location)

560 Anterior manual and or elastic compressed gravity enhanced high viscosity bladder

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

What is claimed is:

1. A multi-chambered fluid delivery system, comprising:
a first chamber;
a second chamber;
a first delivery tube having a first end and a second end, said first delivery tube in communication with said first chamber at the first end of said first delivery tube;
a second delivery tube having a first end and a second end, said second delivery tube in communication with said second chamber at the first end of said second delivery tube;
a first mixing valve having a first input port, a second input port and an outlet, the second end of said first delivery tube attached to the first input port of the first mixing valve to provide communication between the first mixing valve and the first chamber, the second end of said second delivery tube attached to the second input port of the first mixing valve to provide communication between the first mixing valve and the second chamber; and
first means for directing either content from said first chamber, content from said second chamber or a combination of content from said first chamber and said second chamber to the outlet of the first mixing valve.

2. The multi-chambered fluid delivery system of claim 1 further comprising a cushioning member for housing said first chamber and said second chamber.

3. The multi-chamber fluid delivery system of claim 2 further comprising:
a removable third chamber contained by said cushioning member;
a removable fourth chamber contained by said cushioning member;
a third delivery tube having a first end and a second end, said third delivery tube in communication with said third chamber at the first end of said third delivery tube;
a fourth delivery tube having a first end and a second end, said fourth delivery tube in communication with said fourth chamber at the first end of said fourth delivery tube;
a second mixing valve having a first input port, a second input port and an outlet, the second end of said third delivery tube attached to the first input port of the second mixing valve to provide communication between the second mixing valve and the third chamber, the second end of said fourth delivery tube attached to the second input port of the second mixing valve to provide communication between the second mixing valve and the fourth chamber; and
second means for directing either content from said third chamber, content from said fourth chamber or a combination of content from said third chamber and said fourth chamber to the outlet of the second mixing valve.

4. The multi-chambered fluid delivery system of claim 1 wherein said first mixing valve having a bite valve attached at the outlet of the first mixing valve, wherein upon biting down on the bite valve by the user, the user is permitted to draw content from said first chamber, said second chamber or both said first chamber and said second chamber as determined by said first means for directing.

5. The multi-chambered fluid delivery system of claim 3 wherein said first mixing valve having a first bite valve attached at the outlet of the first mixing valve, wherein upon biting down on the first bite valve by the user, the user is permitted to drawn content from said first chamber, said second chamber or both said first chamber and said second chamber as determined by said first means for directing; wherein said second mixing valve having a second bite valve attached at the outlet of the second mixing valve, wherein upon biting down on the second bite valve by the user, the user is permitted to drawn content from said third chamber, said fourth chamber or both said third chamber and said fourth chamber as determined by said second means for directing.

6. The multi-chambered fluid delivery system of claim 1 further comprising a fabric pack for housing said first chamber and said second chamber.

7. The multi-chambered fluid delivery system of claim 1 wherein said first mixing valve having a third port for attachment of an additional delivery tube, said additional delivery tube providing communication between the first mixing valve and a disposable chamber, said first means for directing controlling access to the content contained with the disposable chamber.

8. The multi-chambered fluid delivery system of claim 6 wherein said first mixing valve having a third port for attachment of an additional delivery tube, said additional delivery tube providing communication between the first mixing valve and a disposable chamber, said first means for directing controlling access to the content contained with the disposable chamber, said disposable chamber housed by said fabric pack.

9. The multi-chambered fluid delivery system of claim 8 wherein said disposable chamber is an intra-venous bag.

10. The multi-chambered fluid delivery system of claim 1 wherein said first chamber is larger in internal volume size as compared to an internal volume size of said second chamber.

11. The multi-chambered fluid delivery system of claim 2 wherein said cushioning member is attached to an adaptor, said adaptor permitting said cushioning member to be attached to a garment.

12. The multi-chambered fluid delivery system of claim 11 wherein said garment is body armor.

13. The multi-chambered fluid delivery system of claim 11 wherein said cushioning member is disposed between a front side of a user and the garment.

14. The multi-chambered fluid delivery system of claim 11 wherein said cushioning member is disposed between a back side of a user and the garment.

15. The multi-chambered fluid delivery system of claim 1 wherein said first chamber contains water and said second chamber contains a fluid electrolyte drink.

16. The multi-chambered fluid delivery system of claim 3 wherein said first chamber contains water, said second chamber contains a fluid electrolyte drink, said third chamber contains a simple carbohydrate liquid and said fourth chamber contains a complex carbohydrate solution including branched chain amino acids for sustained support of blood sugar.

17. The multi-chambered fluid delivery system of claim 8 wherein said disposable chamber contains a potable intra-venous fluid.

18. The multi-chambered fluid delivery system of claim 15 wherein said disposable chamber contains a potable intra-venous fluid.
